(19) United States
(12) Patent Application Publication
(10) Pub. No.: US 2007/0255690 A1
(43) Pub. Date: Nov. 1, 2007

(54) System and method for forecasting the performance of advertisements

(76) Inventors: Chi-Chao Chang, Santa Clara, CA (US); Xindong Qian, Fremont, CA (US); Cathy Lin, Santa Clara, CA (US); Haixin Tie, Milpitas, CA (US)

Correspondence Address: THELEN REID BROWN RAYSMAN & STEINER LLP, PO BOX 1510, 875 Third Avenue, 8th Floor, NEW YORK, NY, 10150-1510, US

(21) Appl. No.: 11/414,516

(22) Filed: Apr. 28, 2006

(51) Int. Cl. G06F 17/30

(52) U.S. Cl. 707/3

(57) ABSTRACT

The present invention is directed towards systems and methods for generating a forecast of the performance of one or more advertisements associated with a given bidded search term. The method of the present invention comprises retrieving advertising metric data for one or more advertisements associated with a bidded search term. The advertising metric data retrieved is aggregated according to a rank at which the one or more advertisements were displayed in a ranked list of advertisements. One or more advertising metric values are calculated for the one or more advertisements according to the rank at which the one or more advertisements were displayed. An aggregate landscape is generated indicating the forecasted performance of the one or more advertisements at the one or more ranks at which the one or more advertisements were displayed.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The present invention generally provides methods and systems for forecasting the performance of advertisements. More specifically, the present invention provides methods and systems that forecast the performance of one or more advertisements for one or more advertising metrics.

Advertisements are commonly used on the Internet to promote various products and services. Advertisements may comprise banner ads, links to web pages, images, video, text, etc. Advertisements used to promote products on the Internet are commonly displayed in a ranked result in response to a query. The advertisements displayed to a user of a client device may be selected, redirecting a user to a website providing the product or service advertised.

Client devices, communicatively coupled to a network, such as the Internet, are capable of accessing various websites that may display advertisements. For example, a user of a client device may submit a search query comprising one or more terms to a search engine, which causes the search engine to retrieve a result set comprising links to content, as well as advertisements responsive to the search terms provided by a user. The search engine may display the result set that it generates to a user who may then select or view items in the result set, including one or more advertisements.

The Internet provides advertisers with the ability to reach a significant quantity of users, thereby increasing the likelihood that a given product or service is purchased by a user. Advertisers, however, must pay for the advertisements that a search engines displays in response to various requests. For example, in a bidding market place advertisers may bid upon keywords or terms (“bidded search terms”) associated with one or more advertisements. Queries received by a search engine comprising one or more bidded search terms may be used to select advertisements based upon advertiser bid amount for the respective bidded search terms.

Therefore, while Internet advertising may allow an advertiser to increase the likelihood that products or services are purchased, Internet advertising also involves expending resources. Because advertisers are expending resources on advertisements, the performance of advertisements is a significant concern. The performance of advertisements may be based upon the frequency with which advertisements are displayed in response to a given search query. Similarly, the performance of advertisements may be based upon the frequency with which users select advertisements.

In a bidding marketplace, the performance of advertisements may be closely related to the bidded search terms associated with the advertisements. For example, an advertisement with the greatest associated bid for a given bidded search term may be displayed first in a ranked list of advertisements in response to a search comprising the bidded search term. An advertisement ranked and displayed first in a result set is more likely to be selected by a given user than an advertisement ranked seventh, eight, ninth, etc. Similarly, an advertisement with the greatest associated bid for a given bidded search term may be displayed one thousand times in response to a search comprising the bidded search term, whereas an advertisement with a lesser bid for the same bidded search term may be displayed only fifty times in response to a search comprising the bidded search term.

Advertisers may wish to ascertain such performance information prior to bidding upon one or more bidded search terms associated with one or more advertisements. While current techniques may provide an advertiser with information identifying the performance of advertisements, existing techniques are limited to providing such information only after an advertiser's one or more advertisements are distributed. Existing techniques thus fail to provide information indicating the projected or forecasted performance of one or more advertisements associated with one or more bidded search terms. In order to overcome shortcomings associated with existing techniques, the present invention provides systems and methods for forecasting the performance of one or more advertisements associated with one or more bidded search terms for one or more advertising metric values.

### SUMMARY OF THE INVENTION

The present invention is directed towards methods and systems for generating a forecast of the performance of one or more advertisements associated with a given bidded search term. The method of the present invention comprises retrieving advertising metric data for one or more advertisements associated with a bidded search term. The advertising metric data retrieved for the one or more advertisements associated with the bidded search term may comprise data for a given duration of time, data indicating a rank at which the one or more advertisements were displayed in a ranked list of advertisements in response to a search request comprising the bidded search term, and data indicating a frequency with which the one or more advertisements were selected in response to a search request comprising the bidded search term. Additionally, the advertising metric data retrieved may comprise data indicating a quality score associated with the one or more advertisements and data indicating a bid amount associated with the one or more advertisements with respect to the bidded search term.

The advertising metric data is aggregated according to a rank at which the one or more advertisements were displayed in a ranked list of advertisements. According to one embodiment of the invention, the advertising metric data is aggregated with respect to the bidded search term and the one or more ranks at which the one or more advertisements were displayed in a ranked list of advertisements in response to a search request comprising the bidded search term.

One or more advertising metric values are calculated for the one or more advertisements according to the rank at which the one or more advertisements were displayed. According to one embodiment of the invention, calculating one or more advertising metric values comprises calculating an average frequency with which the one or more advertisements displayed at a given rank were selected, and calculating an average expected cost per one thousand impressions for the one or more advertisements displayed at the given rank. Calculating an expected cost per one thousand impressions may comprise calculating a product of an average bid amount and an average quality score associated with the one or more advertisements displayed at a given rank.

An aggregate landscape is generated indicating the forecasted performance of the one or more advertisements at the one or more ranks at which the one or more advertisements were displayed. According to one embodiment of the invention, generating an aggregate landscape comprises generating a report, which may comprise a graph, indicating the average frequency with which the one or more advertisements were selected and the average cost per one thousand impressions for the one or more ranks at which the one or more advertisements were displayed.

The method of the present invention further comprises generating an advertiser specific landscape for one or more advertiser specified advertisements. According to one embodiment, generating an advertiser specific landscape comprises retrieving a quality score associated with the one or more advertiser specified advertisements and calculating one or more advertiser specific advertising metric values for the one or more advertiser specified advertisements using the quality scores associated with the one or more advertiser specified advertisements. Calculating one or more advertiser specific advertising metric values for the one or more advertiser specified advertisements may comprise calculating an advertiser specific bid amount indicating a bid amount needed for the one or more advertiser specified advertisements to be displayed at a given rank. Calculating one or more advertiser specific advertising metric values for the one or more advertiser specified advertisements may also comprise calculating a frequency with which the one or more advertiser specified advertisements are to be selected at a given rank.

The present invention is further directed towards a system for generating a forecast of the performance of one or more advertisements associated with a given bidded search term. The system of the present invention comprises a data warehouse operative to store advertising metric data for one or more advertisements associated with the bidded search term. The data warehouse is operative to store advertising metric data indicating a rank at which the one or more advertisements were displayed in a ranked list of advertisements, a bid amount associated with the one or more advertisements, and a quality score for the one or more advertisements.

A back end service is operative to aggregate the advertising metric data associated with the one or more advertisements according to a rank at which the one or more advertisements were displayed, and calculate one or more advertising metric values for the one or more advertisements displayed at a given rank. According to one embodiment, the back end service is operative to aggregate the advertising metric data received according to the rank at which the one or more advertisements were displayed in a ranked list of advertisements in response to a search request comprising the bidded search term. The back end service is further operative to calculate an average frequency with which the one or more advertisements were selected at a given rank, an average expected cost per thousand impressions for the one or more advertisements displayed at a given rank, and an average quality score for the one or more advertisements displayed at a given rank.

A front end service is operative to generate an aggregate landscape indicating the forecasted performance of the one or more advertisements using the one or more advertising metric values. According to one embodiment of the invention, the front end service generates an aggregate landscape in response to an advertiser request comprising the bidded search term. The aggregate landscape generated by the front end service may indicate an average frequency with which the one or more advertisements are to be selected at a given rank and an average expected cost per one thousand impressions for the one or more advertisements displayed at a given rank.

The front end service is further operative to generate an advertiser specific landscape for one or more advertiser specified advertisements associated with the bidded search term. According to one embodiment of the invention, the front end service is operative to receive a request identifying one or more advertiser specified advertisements associated with the bidded search term and retrieve a quality score associated with the one or more advertiser specified advertisements. The front end service calculates one or more advertiser specific advertising metric values for the one or more advertiser specified advertisements using the quality scores associated with the one or more advertiser specified advertisements.

According to one embodiment, the front end service calculates the one or more advertiser specific advertising metric values using the quality scores associated with the one or more advertiser specified advertisements and the aggregate landscape associated with the bidded search term. The one or more advertiser specific advertising metric values may comprise a bid amount indicating a bid amount needed for the one or more advertiser specified advertisements to be displayed at a given rank in response to a search request comprising the bidded search term. Additionally, the one or more advertiser specific advertising metric values may comprise a frequency with which the one or more advertiser specified advertisements would be selected at a given rank when displayed in response to a search request comprising the bidded search term. The front end service generates an advertiser specific landscape using the one or more advertiser specific advertising metric values. According to one embodiment, the front end service generates an advertiser specific landscape indicating the frequency with which the one or more advertiser specified advertisements are to be selected and the bid amount for the one or more advertiser specified advertisements at a given rank.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram presenting a system for receiving advertising metric data associated with one or more advertisements and generating a forecast of the performance of one or more advertisements in response to a request according to one embodiment of the present invention;

FIG. 2 is a flow diagram illustrating one embodiment of a method for receiving and storing advertising metric data for one or more advertisements associated with a given bidded search term according to one embodiment of the present invention;

FIG. 3 is a flow diagram illustrating one embodiment of a method for calculating one or more advertising metric values for one or more advertisements associated with a given bidded search term according to one embodiment of the present invention;

FIG. 4 is a flow diagram illustrating one embodiment of a method for generating a forecast landscape of the performance of one or more advertisements associated with a given bidded search term in response to an advertiser request according to one embodiment of the present invention; and

FIG. 5 is a flow diagram illustrating one embodiment of a method for generating a forecast landscape of the performance of one or more advertiser specific advertisements associated with a given bidded search term in response to an advertiser request according to one embodiment of the present invention.

### DETAILED DESCRIPTION OF THE PREFERRED EMBODIMENT

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

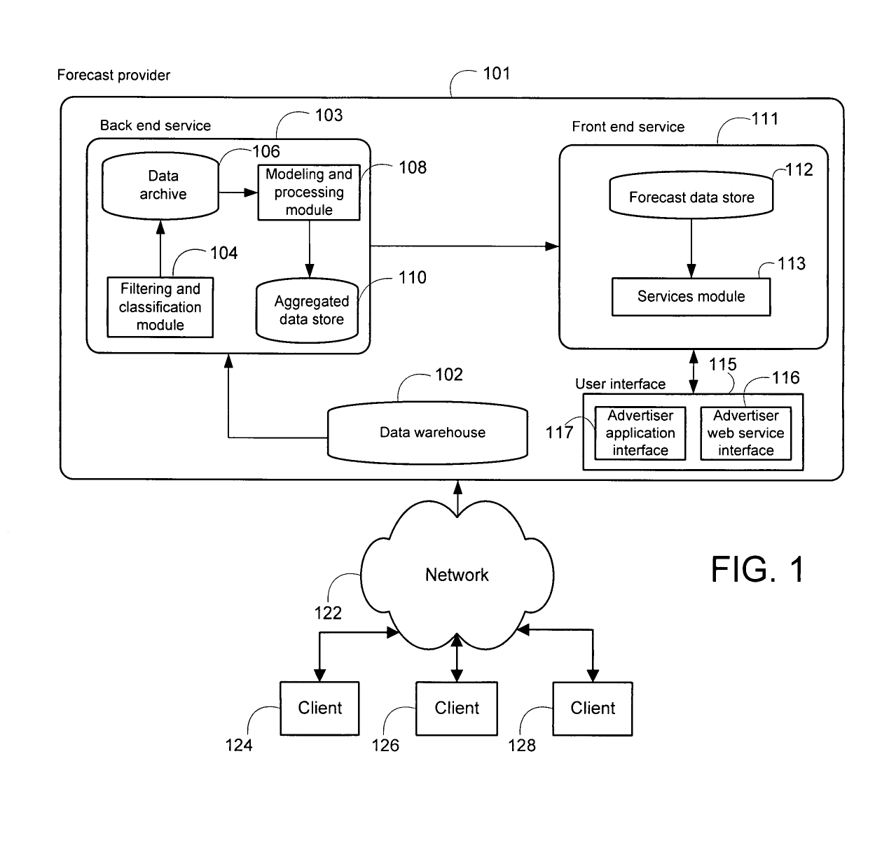

FIG. 1 presents a block diagram depicting one embodiment of a system for forecasting the performance of one or more advertisements associated with one or more bidded search terms. The bids provided by one or more advertisers for a bidded search term associated with one or more advertisements may be used to select and rank the advertisements in response to a request. For example, a search engine may receive a request comprising a given bidded search term. The search engine may identify the one or more advertisements associated with the bidded search term. Additionally, the search engine may identify the one or more bid amounts for the bidded search term provided by the advertisers associated with the identified advertisements. The bid amounts may be used to rank the one or more identified advertisements. For example, the advertisement associated with the advertiser that provided the greatest bid amount for the bidded search term may be placed first in a ranked list of advertisements.

A search engine may further utilize a quality score to determine a ranking for one or more advertisements associated with a given bidded search term. A quality score may comprise a numerical indication of advertisement performance quality that is based upon one or more performance parameters to quantify the relative quality of an advertisement, e.g., clickability. According to one embodiment of the invention, a quality score comprises a numerical indication of the relative quality of an advertisement with respect to one or more bidded search terms. For example, a quality score may comprise an indication of the extent to which a given advertisement matches or is similar to a given bidded search term. Alternatively, or in conjunction with the foregoing, a quality score may comprise an indication of the reliability of an advertisement with respect to a given bidded search term. For example, an index may be maintained identifying advertisements that are associated with questionable or unreliable content, thereby resulting in a decreased quality score. Those of skill in the art recognize numerous techniques for calculating a quality score for a given advertisement with respect to a given bidded search term.

Advertisements distributed in response to requests may be viewed or selected. For example, an advertisement displayed to a user in a ranked list of advertisements may be selected, resulting in the retrieval of the content associated with the advertisement. Additionally, data regarding the selection of an advertisement may be retrieved. According to one embodiment of the invention, the data associated with the selection of a given advertisement is delivered to a data warehouse 102 at a forecast provider 101. The data warehouse 102 may be implemented as a relational database or any other type of storage structure capable of providing for the storage and retrieval of data associated with one or more advertisements.

The data delivered to the data warehouse 102 for a given advertisement may comprise data indicating the bidded search term associated with the advertisement, the bid provided by the advertiser associated with the advertisement for the bidded search term, the rank of the advertisement in a ranked list of advertisements in response to a request comprising the bidded search term, the quality score of the advertisement, and an identifier that may be used to identify the advertisement.

According to one embodiment of the invention, the data received by the data warehouse 102 is aggregated and maintained according to bidded search term and rank for one or more advertisements. For example, the data warehouse 102 may group the data for one or more advertisements associated with the bidded search term “flower” that were displayed in position one of a ranked list of advertisements. Similarly, the data warehouse 102 may group the data for one or more advertisements associated with the bidded search term “flower” that were displayed in position two of a ranked list of advertisements.

A back end service 103 at the forecast provider 101 may periodically retrieve data received and aggregated by the data warehouse 102 during a given period of time for one or more advertisements associated with a given bidded search term. According to one embodiment of the invention, the back end service 103 is operative to retrieve the data received and aggregated by the data warehouse 102 for one or more advertisements associated with a given bidded search term during a twenty-four hour period of time. For example, the back end service 103 may retrieve the data for the one or more advertisements associated with the bidded search term “computer” that was received by the data warehouse 102 during a twenty-four hour period of time.

A filtering and classification module 104 at the back end service 103 is operative to categorize the data retrieved. According to one embodiment, the filtering and classification module 104 is operative to parse retrieved data to determine a match classification for a given item of incoming data. For example, the filtering and classification module 104 may include classifying retrieved data as an exact match, a broad match, etc. The filtering and classification module 104 may be operative to modify the received data with the determined classification, which may then be used for storing data according to category. Alternatively, the filtering and classification module 104 may receive data with classification information, which is used for storage or filtering purposes.

The data retrieved and categorized by the back end service 103 for a given period of time for one or more advertisements associated with a given bidded search term is delivered to and maintained in a data archive 106. The data archive 106 may be implemented as a relational database or any other type of storage structure capable of providing for the storage and retrieval of data associated with one or more advertisements. The data archive 106 is operative to maintain the data corresponding to given period of time for one or more advertisements associated with a given bidded search term according to the bidded search term and rank associated with the advertisements. For example, the data delivered to the data archive 106 may comprise the data corresponding to a twenty-four hour period of time for one or more advertisements associated with the bidded search term “vacation.”

The data delivered to the data archive 106 may comprise a plurality of data, including but not limited to, the rank of the one or more advertisements in a ranked list of advertisements displayed in response to a search request comprising a given bidded search term. The data archive 106 may utilize the rank to group the advertisements displayed in response to the bidded search term during a given period of time. For example, the data archive 106 may group the one or more advertisements associated with a bidded search term that were displayed at rank one during a given period of time as indicated by the data received. Similarly, the data archive 106 may group the one or more advertisements associated with a bidded search term that were displayed at rank two during a given period of time as indicated by the data received.

A modeling and processing module 108 is operative to retrieve the data maintained in the data archive 106 and calculate one or more advertising metric values for one or more advertisements associated with a given bidded search term. The modeling and processing module 108 may retrieve the data maintained in the data archive 106 and calculate one or more advertising metric values for the one or more advertisements associated with a bidded search term. According to one embodiment of the invention, the modeling and processing module 108 is operative to calculate the average frequency with which one or more advertisements were selected by one or more users during a given duration of time. For example, the modeling and processing module may calculate the average frequency with which the one or more advertisements displayed at rank three in response to the bidded search term “cars” were selected during a twenty-four hour period. The modeling and processing module 108 is further operative to calculate the average bid, as provided by one or more advertisers, for the bidded search term associated with the one or more advertisements displayed at a given rank as indicated by the data retrieved from the data archive 106. For example, the modeling and processing module 108 may calculate the average bid provided by advertisers for the bidded search term “cars” for the one or more advertisements displayed at rank two in a ranked list of advertisements in response to a search request comprising the search term “cars.”

The modeling and processing module 108 may store the one or more calculated advertising metric values for a given bidded search term and rank in an aggregated data store 110, which may comprise a relational database or any other type of storage structure capable of providing for the storage and retrieval of data associated with one or more advertisements. Additionally, the modeling and processing module 108 is operative to combine existing data maintained in the aggregated data store 110 with the one or more calculated advertising metric values for the data retrieved from the data archive 106. For example, as previously described the modeling and processing module 108 may calculate the average frequency with which one or more advertisements associated with the bidded search term “wireless” are selected when displayed at rank one of a ranked list of advertisements during a given period of time. The modeling and processing module 108 may thereafter inspect the aggregated data store 110 to determine whether there is any existing data indicating the frequency with which the one or more advertisements associated with the bidded search term “wireless” and rank one are selected.

Where the modeling and processing module 108 identifies existing data maintained in the aggregated data store 110 for one or more advertisements associated with a given bidded search term and rank, the modeling and processing module 108 combines the existing data with the one or more advertising metric values calculated for the data retrieved from the data archive 106. For example, with reference to the abovementioned example, the modeling and processing module 108 may identify existing data maintained in the aggregated data store 110 for one or more advertisements associated with the bidded search term “wireless” and rank one, such as the frequency with which the one or more advertisements are selected. The modeling and processing module 108 may combine the existing data in the aggregated data store 110 with the one or more advertising metric values calculated by the modeling and processing module 108 for the data retrieved from the data archive 106. For example, the modeling and processing module 108 may average the existing frequency data with the frequency data calculated for the data retrieved from the data archive 106.

The one or more advertising metric values associated with a given bidded search term and rank maintained in the aggregated data store 110 may be delivered to a forecast data store 112 at a front end service 111. The forecast data store 112 may be implemented as a relational database or any other type of storage structure capable of providing for the storage and retrieval of advertising metric values associated with one or more advertisements and bidded search terms.

The front-end service 111 utilizes the data maintained in the forecast data store 112 to generate a forecast for a given bidded search term in response to an advertiser request. According to one embodiment of the invention, advertisers communicatively coupled to a network 122 such as the Internet may utilize client devices 124, 126, and 128 to deliver requests to the front-end service 111 at the forecast provider 101. A client device 124a, 124b and 124c may comprise a general purpose personal computer comprising a processor, transient and persistent storage devices, input/output subsystem and bus to provide a communications path between components comprising the general purpose personal computer. For example, a 3.5 GHz Pentium 4 personal computer with 512 MB of RAM, 40 GB of hard drive storage space and an Ethernet interface to a network. Other client devices are considered to fall within the scope of the present invention including, but not limited to, hand held devices, set top terminals, mobile handsets, PDAs, etc.

Advertisers utilizing client devices 124, 126, and 128 may submit requests to the front end service 111 at the forecast provider 101 via a user interface 115. As illustrated in FIG. 1, the user interface 115 comprises an advertiser application interface 117 and an advertiser web service interface 116. The advertiser application interface 117 may comprise one or more modules for interfacing and communicating with applications residing and executing on a client device 124, 126, and 128, such as an application operative to generate a request for a forecast associated with a given bidded search term. The advertiser web service interface 116 may comprise one or more modules for interfacing and communicating with a web browser configured on a client device 124, 126, and 128. For example, a given advertiser may utilize a browser configured on a client device 124, 126, and 128 to access a web page operative to receive a request for forecast data associated with a given bidded search term.

According to one embodiment of the invention, a request received from a given advertiser utilizing a client device 124, 126, and 128 via the advertiser application interface 117 or the advertiser web service interface 116 comprises a bidded search term. The bidded search term associated with a request received from a given advertiser is delivered to a services module 113 operative to generate a forecast landscape associated with the bidded search term utilizing the data maintained in the forecast data store 112.

According to one embodiment of the invention, the forecast landscape generated by the services module 113 for a given bidded search term comprises an aggregate landscape, wherein an aggregate landscape indicates the number of user selections and the expected cost per one thousand impressions (“ECPM”) for the one or more advertisements associated with a given bidded search term and rank, wherein an impression comprises the display of a given advertisement. The ECPM associated with a given bidded search term and advertisement is calculated using the product of the bid and quality score associated with the advertisement with respect to the given bidded search term.

For example, the data maintained in the forecast data store 112 may indicate the frequency with which one or more advertisements were selected when displayed in response to the bidded search term “flower” at position two of a ranked list of advertisements. Additionally, the data maintained in the forecast data store 112 may indicate the quality score and bid amount associated with the one or more advertisements displayed in response to the bidded search term “flower” at position two of a ranked list of advertisements. The services module 113 is operative to utilize the data maintained in the forecast data store 112 to generate an aggregate landscape indicating the forecasted performance of the one or more advertisements associated with the bidded search term “flower.” The aggregate landscape indicates the frequency with which the one or more advertisements associated with a given bidded search term are selected at a given rank, as well as the expected cost per thousand impressions of the one or more advertisements displayed at the given rank in response to the given bidded search term.

An advertiser requesting forecast data via the advertiser application interface 117 or the advertiser web service interface 116 may further specify an advertisement or advertisement group to obtain an advertiser specific landscape for the advertiser's one or more advertisements associated with the bidded search term. As previously described, a unique identifier may be associated with the one or more advertisements associated with a given advertiser. A request for forecast data received from a given advertiser may comprise a bidded search term as well as the unique identifier for one or more of the advertiser's advertisements associated with the bidded search term. The services module 113 may utilize the unique identifier to generate an advertiser specific landscape. According to one embodiment of the invention, the services module 113 utilizes the unique identifier to retrieve the quality score data associated with the advertiser specified advertisements in order to generate an advertiser specific landscape.

The quality score data associated with the advertiser specified advertisements may be used to generate an advertiser specific landscape indicating the forecasted performance of the one or more advertisements at one or more bid amounts for a given bidded search term. The aggregate and advertiser specific landscapes generated in response to an advertiser request for a given bidded search term may be delivered to the respective advertiser. For example, the aggregate and advertiser specific landscapes may be delivered via the network 122 to a client device 124, 126, and 128 associated with a given advertiser.

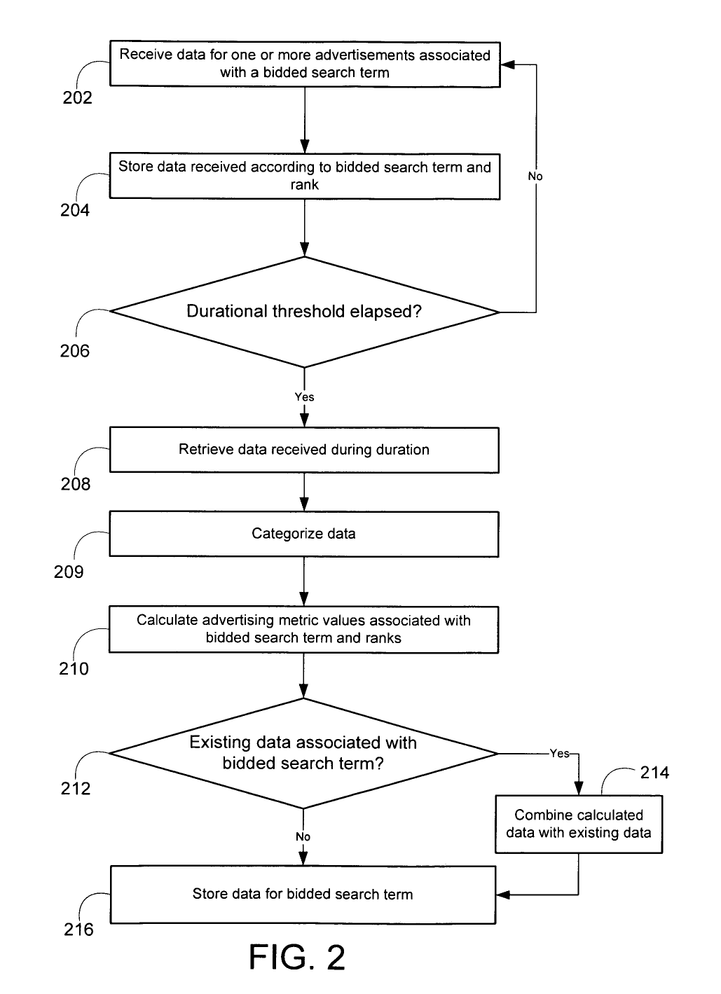

FIG. 2 presents a flow diagram illustrating one embodiment of a method for receiving and aggregating advertising metric data for one or more advertisements associated with a given bidded search term. Advertising metric data for one or more advertisements associated with a given bidded search term is received, step 202. The advertising metric data received may comprise data indicating the frequency with which one or more advertisements were selected when displayed in response to the bidded search term, the rank of the advertisements when displayed in response to the bidded search term, and the bid associated with the advertisements for the bidded search term.

The data received for the one or more advertisements is stored in a data warehouse according to the bidded search term associated with the advertisements and the rank at which the one or more advertisements were displayed in response to the bidded search term, step 204. For example, data for the one or more advertisements displayed in response to the bidded search term “laptop” may be received. The data may indicate the rank at which the one or more advertisements were displayed in response to the bidded search term “laptop,” such as rank one, two, three, etc., of a ranked list of advertisements. The data warehouse may group the one or more advertisements displayed in response to the bidded search term “laptop” based upon rank, such as grouping the one or more advertisements displayed in response to the bidded search term “laptop” at rank one, e.g., rank based aggregation.

A check is performed to determine whether a durational threshold has elapsed, step 206. A durational threshold comprises a time period during which data is received and aggregated in the data warehouse. According to one embodiment of the invention, the durational threshold comprises a twenty-four hour period of time during which the data associated with a given bidded search terms is received and aggregated according to the bidded search term and rank.

If the durational threshold has not elapsed, processing returns to step 202 and data continues to be received, step 202, and stored according to the bidded search term and rank, step 204. When the durational threshold has elapsed, the data received for the bidded search term during the duration is retrieved, step 208. The data retrieved is categorized, which may include parsing retrieved data to determine a match classification for a given item of incoming data. For example, classifying retrieved data as an exact match, a broad match, etc.

One or more advertising metric values are calculated for the data retrieved, step 210. A given advertising metric value may comprise an indication of the advertising metric events for the one or more advertisements associated with a given bidded search term and rank. For example, an advertising metric value may comprise the average number of users who selected a given advertisement when displayed at rank two of a ranked list of advertisements in response to the bidded search term “wireless.” Similarly, an advertising metric value may comprise the average bid provided by advertisers for the one or more advertisements displayed in response to the bidded search term “wireless” at rank two of a ranked list of advertisements. Additionally, an advertising metric value may comprise the average quality score of the one or more advertisements displayed at rank two of a ranked list of advertisements in response to the bidded search term “wireless.”

A check is performed to determine whether there is any existing data for the given bidded search term, step 212. If existing data is identified for the given bidded search term, the one or more advertising metric values calculated for the data retrieved are combined with the existing data for the bidded search term. Combining the existing with the one or more advertising metric values calculated for the data retrieved may comprise calculating an average advertising metric value. For example, the existing data for the bidded search term “wireless” may indicate that advertisements displayed in position two of a ranked list of advertisements in response to the bidded search term “wireless” were selected an average of one hundred times. The advertising metric values calculated for the data retrieved, however, may indicate that that the advertisements displayed in position two of a ranked list of advertisements in response to the bidded search term “wireless” were selected an average of two hundred times during a given duration. An average advertising metric value may be calculated based upon the existing data as well as the advertising metric values calculated for the data retrieved.

If existing data is not found for the bidded search term, step 212, or after the existing data has been combined with the one or more advertising metric values associated with the bidded search term, the data for the bidded search term is stored, step 216. Storing the data for the bidded search term may comprise storing the data in a database or other type of storage structure capable of providing for the storage and retrieval of data.

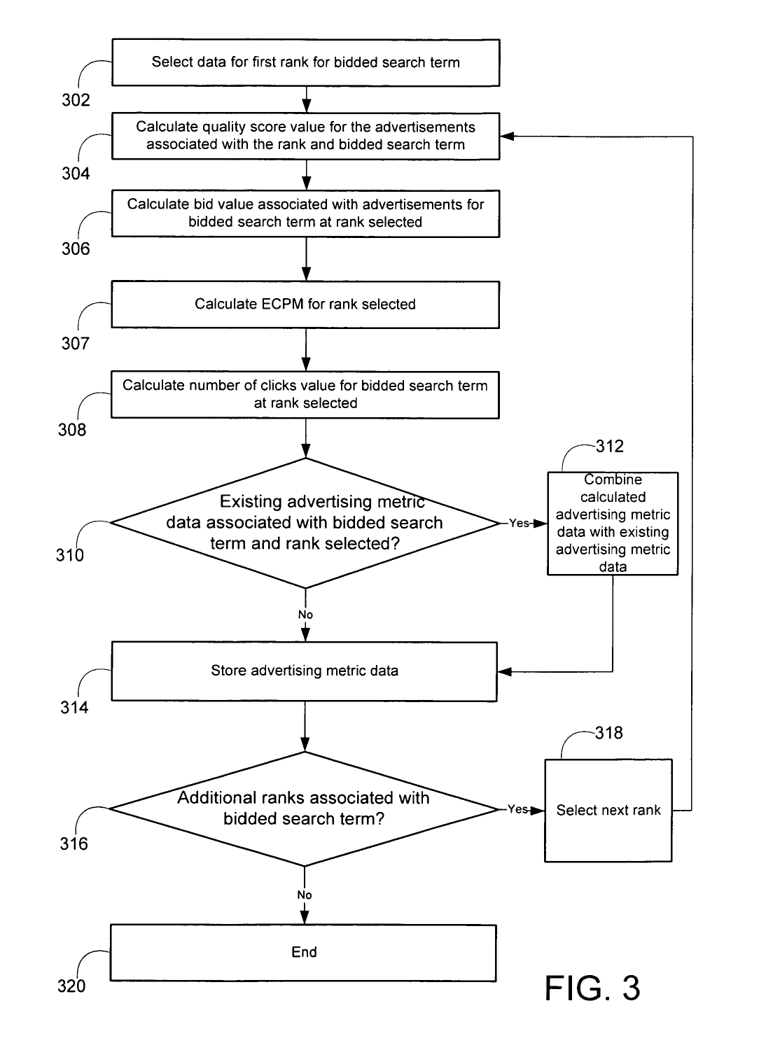

FIG. 3 presents a flow diagram illustrating one embodiment of a method for calculating one or more advertising metric values for one or more advertisements associated with a given bidded search term. Data associated with a first rank for one or more advertisements associated with a given bidded search term is selected, step 302. For example, data for the one or more advertisements associated with the bidded search term “computer” displayed at rank one (“1”) of a ranked list of advertisements is selected. A quality score value corresponding to the one or more advertisements associated with the bidded search term and rank is calculated, step 304. For example, a quality score value may comprise the average quality score of the one or more advertisements associated with the bidded search term and rank selected. Similarly, a quality score value may comprise the minimum or maximum quality score of the one or more advertisements associated with the bidded search term and rank selected. According to one embodiment of the invention, a quality score comprises a numerical indication of the relative quality of a given advertisement with respect to a given bidded search term.

A bid value corresponding to the bids provided by one or more advertisers for the bidded search term associated with the one or more advertisements displayed at the rank selected is calculated, step 306. According to one embodiment of the invention, a bid value comprises the average bid provided by one or more advertisers for the bidded search term associated with the one or more advertisements displayed at the rank selected. For example, the average bid provided by the one or more advertisers for the bidded search term “computer” associated with the one or more advertisements displayed at rank one (“1”) of a ranked list of advertisements may be calculated.

The bid value and the quality score value corresponding to the one or more advertisements associated with the bidded search term and rank selected are used to calculate the expected cost per thousand impressions (“ECPM”) for the one or more advertisements, step 307. According to one embodiment of the invention, the ECPM for the one or more advertisements associated with a bidded search term and rank comprises the product of the bid value and the quality score value corresponding to the one or more advertisements associated with the bidded search term and rank selected. For example, the ECPM for one or more advertisements associated with a bidded search term and rank may comprise the product of the average bid and the average quality score for the one or more advertisements associated with the bidded search term and rank selected.

A value corresponding to the number of users who selected the one or more advertisements displayed at the rank selected in response to the bidded search term is thereafter calculated, step 308. According to one embodiment of the invention, the value corresponding to the number of users who selected the one or more advertisements displayed at the rank selected in response to the bidded search term comprises the average number of users who selected the one or more advertisements displayed at the rank selected. A check is performed to determine whether there is any existing advertising metric data associated with the bidded search term and rank selected, step 310. For example, a check may be performed to determine whether there is any existing data associated with the one or more advertisements displayed in response to the bidded search term “computer” at rank one of a ranked list of advertisements. If existing advertising metric data is identified for the bidded search term and rank selected, the existing data is combined with the calculated advertising metric values for the bidded search term and rank selected, step 312. Combining the existing advertising metric data with the calculated advertising metric values for a given bidded search term and rank may comprise averaging the existing advertising metric data with the calculated advertising metric values. If existing advertising metric data is not identified for the bidded search term and rank selected, or after the existing data has been combined with the calculated advertising metric values, the advertising metric data is stored in a storage structure capable of providing for the storage and retrieval of advertising metric data, step 314.

A check is thereafter performed to determine whether there are any additional ranks associated with the bidded search term, step 316. For example, after examining the one or more advertisements displayed at position one of a ranked list of advertisements in response to the bidded search term “computer,” a check may be performed to determine whether there are any advertisements associated with the bidded search term “computer” that were displayed at position two of a ranked list of advertisements. If additional ranks are identified for the bidded search term, the next rank is selected, step 318. After the one or more ranks associated with a given bidded search term have been examined, processing terminates, step 320.

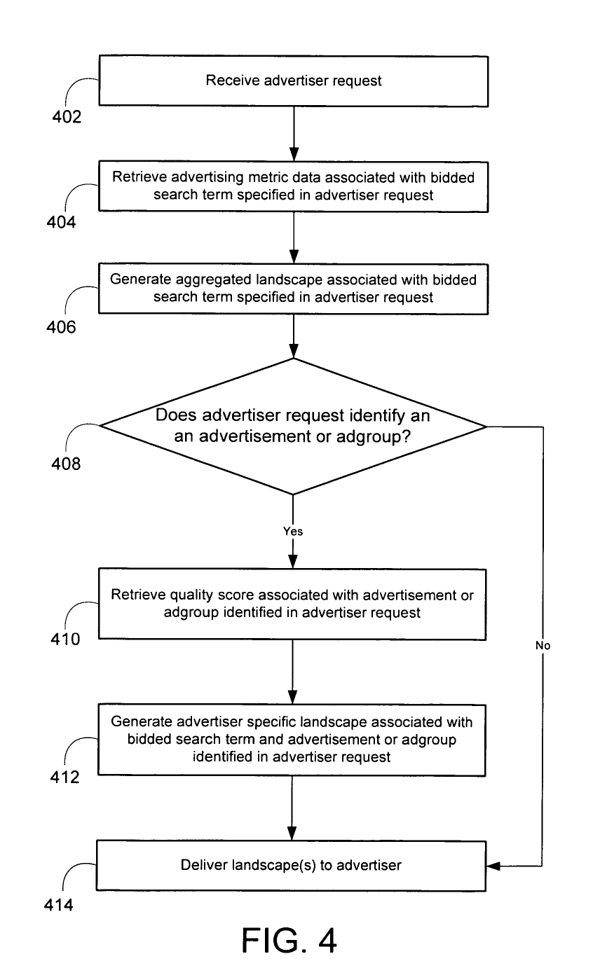

FIG. 4 is a flow diagram illustrating one embodiment of a method for generating an aggregated forecast landscape of the performance of one or more advertisements associated with a given bidded search term in response to an advertiser request. As illustrated in FIG. 4, an advertiser request is received, step 402. An advertiser request may comprise a bidded search term for which an advertiser wishes to receive an aggregated forecast. An advertiser request may further comprise an identifier corresponding to a given advertisement or advertisement group, which may be used to generate an advertiser specific forecast according to methods further described herein.

An aggregated landscape is generated for the bidded search term specified in the advertiser request, step 406, wherein an aggregated landscape indicates the number of user selections against ECPM for the one or more advertisements associated with a given bidded search term and rank. According to one embodiment of the invention, the ECPM associated with a given bidded search term and advertisement comprises the product of the bid and quality score associated with the advertisement. For example, an aggregate landscape for the bidded search term “flowers” may indicate the average frequency with which the one or more advertisements associated with the bidded search term were selected at a given rank, as well as the average ECPM associated with the one or more advertisements at the given rank. Table A illustrates one embodiment of an aggregate landscape that may be generated in response to a request received from an advertiser for the bidded search term “flower”.

[image]

According to the landscape in Table A, each of the square data points indicates a rank associated with the one or more advertisements displayed in response to the bidded search term “flower.” According to the aggregate landscape illustrated in Table A, “ECPM” comprises the average expected cost per one thousand impressions, which is calculated using the product of the bid and quality score of the one or more advertisements associated with a given bidded search term at a given rank. “Clicks” comprises the average frequency with which users selected the one or more advertisements displayed in response to the bidded search term “flower” at a given rank.

A check is thereafter performed to determine whether the request received from the advertiser identified an advertisement or advertisement group, step 408. If the advertiser request did not identify an advertisement or advertisement group, the aggregate landscape for the bidded search term specified in the advertiser request is delivered to the advertiser with which the request originated, step 414. Alternatively, if the request identifies an advertisement or advertisement group, the quality score associated with the advertisement or advertisement group is retrieved, step 410. According to one embodiment of the invention, the quality score for the one or more advertisements in a given advertisement group comprises the average quality score of the one or more advertisements. According to another embodiment of the invention, the quality score for the one or more advertisements in a given advertisement group comprises the quality score associated with the advertisement with the lowest quality score in the advertisement group. According to a further embodiment of the invention, the quality score for the one or more advertisements in a given advertisement group comprises the quality score associated with the advertisement with the greatest quality score in the advertisement group.

The quality score associated with the advertisement or advertisement group identified in the advertiser request is used to generate an advertiser specific landscape for the bidded search term with respect to the one or more advertiser specified advertisements, step 412. An advertiser specific landscape indicates one or more advertising metric values associated with a given bidded search term for one or more advertisements associated with a given advertiser. For example, an advertiser specific landscape may indicate the forecasted frequency with which a given advertiser's one or more advertisements may be selected when displayed in response to the bidded search term “computer” when a bid amount of $1.00 is provided by the advertiser.

Table B illustrates one embodiment of the equations that may be used to construct an advertiser specific landscape for one or more advertisements associated with a given bidded search term using an aggregate landscape associated with the bidded search term.

TABLE B

| | |
|---|---|
| Bid($) = ECPM/QS′ | Clicks = (Clicks * QS′)/QS |

According to the equations presented in Table B, “ECPM” comprises the average ECPM for the one or more advertisements displayed at a given rank for a given bidded search term as indicated by an aggregate landscape associated with the bidded search term. QS′ comprises the quality score for the one or more advertisements specified in the request received from the advertiser for a given bidded search term. In order to calculate an advertiser specific landscape, the quotient of the ECPM at a given rank and the quality score of the one or more advertisements specified in the request received from the advertiser are calculated. The calculated quotient yields the forecasted bid amount necessary for the one or more advertiser specified advertisements to be displayed at a given rank.

Additionally, in the equations illustrated in Table B, “Clicks” comprises the average number of users that selected the one or more advertisements displayed at a given rank for a given bidded search term. “QS” comprises the quality score of the one or more advertisements displayed at a given rank for a given bidded search term. As illustrated in Table B, the product of the quality score associated with the one or more advertisements specified in the request received from the advertiser and the clicks associated with the one or more advertisements displayed at a given rank is calculated and divided by the quality score associated with the one or more advertisements displayed at the given rank. The calculated “Clicks” quotient yields the forecasted frequency with which the advertiser specified advertisements are to be selected when displayed at a given rank.

The “Clicks” and “Bid” values may be used to construct an advertiser specific landscape indicating the forecasted performance of one or more advertisements associated with a given bidded search term at one or more bid amounts. Table C illustrates one embodiment of an advertiser specific landscape for the one or more advertisements associated with the bidded search term “flowers” for a given advertiser. The advertiser specific landscape illustrated in Table C may be derived from the aggregate landscape illustrated in Table A utilizing the equations illustrated in Table B.

[image]

In the advertiser specific landscape illustrated in Table C, “Bid” comprises the bid amount for the bidded search term “flowers,” whereas “Clicks” comprises the forecasted number of users that are to select an advertisement displayed in response to the bidded search term “flowers” at a given bid amount. Additionally, each of the data points indicates a rank associated with the one or more advertisements displayed in response to the bidded search term “flower” at a given bid amount.

The aggregated landscape and the advertiser specific landscape may thereafter be delivered to the advertiser with which the request originated, step 414. For example, the aggregated landscape and the advertiser specific landscape may be delivered to and displayed upon the client device associated with the advertiser with which the request originated.

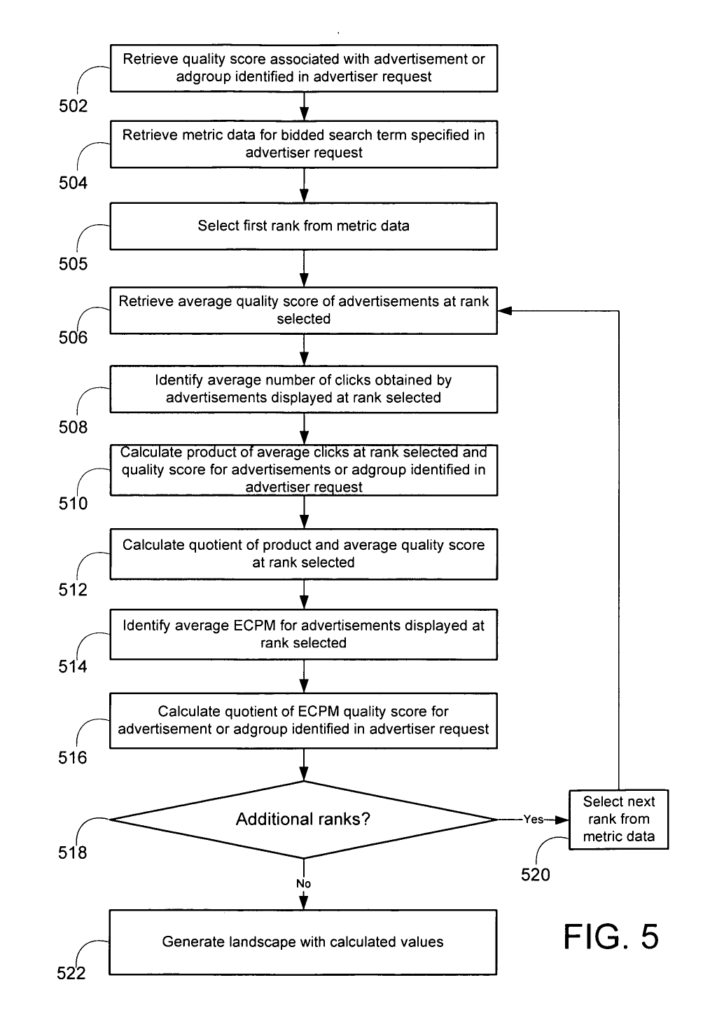

FIG. 5 is a flow diagram illustrating one embodiment of a method for generating a forecast landscape of the performance of one or more advertiser specific advertisements associated with a given bidded search term in response to an advertiser request. The quality score associated with the advertisement or advertisement group identified in a request received from an advertiser is retrieved, step 502. The quality score for the one or more advertisements in a given advertisement group may comprise the average quality score of the one or more advertisements, the greatest quality score among the one or more advertisements, or the lowest quality score among the one or more advertisements.

Advertising metric data for the bidded search term specified in the request received from the advertiser is retrieved, step 504. The advertising metric data for the bidded search term may comprise data indicating the performance of one or more advertisements associated with the bidded search term when displayed at a given rank in a ranked list of advertisements. The first rank associated with the one or more advertisements for the bidded search term is selected, step 505. The average quality score of the one or more advertisements displayed at the rank selected is retrieved, step 506. Additionally, the average frequency with which the one or more advertisements displayed in response to the bidded search term at the rank selected is identified, step 508.

The product of the average frequency with which the one or more advertisements displayed in response to the bidded search term at the rank selected and the quality score for the one or more advertisements specified in the request received from the advertiser is calculated, step 510. The quotient of the calculated product and the average quality score of the one or more advertisements displayed in response to the bidded search term and the rank selected is thereafter calculated, step 512. The calculated quotient identifies the average frequency with which the advertiser's one or more advertisements are to be selected when displayed in response to the bidded search term at the rank selected.

The average ECPM for the one or more advertisements at the rank selected is identified, step 514. The quotient of the average ECPM at the rank selected for the bidded search term and the quality score of the one or more advertisements specified in the advertiser request is calculated, step 516. The calculated quotient identifies the bid amount that is to result in the advertiser's one or more advertisements being displayed at the rank selected.

A check is performed to determine whether one or more ranks are associated with the bidded search term identified in the request received from the advertiser, step 518. If one or more additional ranks are identified, a next rank is selected, step 520. After the one or more ranks associated with the bidded search term specified in the request received from the advertiser have been examined, an advertiser specific landscape is generated using the calculated values, step 522. The advertiser specific landscape provides an advertiser with the ability to view the forecasted performance of one or more advertisements associated with a given bidded search term at one or more bid amounts. The advertiser specific landscape indicates the bid amount and the frequency with which the advertiser's one or more advertisements are to be selected at one or more ranks for the bidded search term. The advertiser may utilize the advertiser specific landscape to develop or modify an advertisement bidding strategy for one or more advertisements associated with a given bidded search term.

The foregoing description, for purposes of explanation, uses specific nomenclature and formula to provide a thorough understanding of the invention. It should be apparent to those of skill in the art that the specific details are not required in order to practice the invention. The embodiments have been chosen and described to best explain the principles of the invention and its practical application, thereby enabling others of skill in the art to utilize the invention and various embodiments with various modifications as are suited to the particular use contemplated. Thus, the foregoing disclosure is not intended to be exhaustive or to limit the invention to the precise forms disclosed and those of skill in the art recognize that many modifications and variations are possible in view of the above teachings.

We claim:

1. A method for generating a forecast of the performance of one or more advertisements associated with a given bidded search term, the method comprising:
retrieving advertising metric data for one or more advertisements associated with the bidded search term;
aggregating the advertising metric data retrieved according to a rank at which the one or more advertisements were displayed in a ranked list of advertisements;
calculating one or more advertising metric values for the one or more advertisements according to the rank at which the one or more advertisements were displayed; and
generating an aggregate landscape indicating a performance forecast for the one or more advertisements at the one or more ranks at which the one or more advertisements were displayed.

2. The method of claim 1 wherein retrieving advertising metric data comprises retrieving data for a given duration of time.

3. The method of claim 1 wherein retrieving advertising metric data comprises retrieving data indicating a rank at which one or more advertisements associated with the bidded search term were displayed in a ranked list of advertisements in response to a search request comprising the bidded search term.

4. The method of claim 1 wherein retrieving advertising metric data comprises retrieving data indicating a frequency with which the one or more advertisements were selected in response to a search request comprising the bidded search term.

5. The method of claim 1 wherein retrieving advertising metric data comprises retrieving data indicating a quality score associated with the one or more advertisements with respect to the bidded search term.

6. The method of claim 1 wherein retrieving advertising metric data comprises retrieving data indicating a bid amount associated with the one or more advertisements with respect to the bidded search term.

7. The method of claim 1 wherein aggregating the advertising metric data retrieved comprises aggregating the data with respect to the bidded search term and the one or more ranks at which the one or more advertisements were displayed in a ranked list of advertisements in response to a search request comprising the bidded search term.

8. The method of claim 1 wherein calculating one or more advertising metric values for the one or more advertisements according to the rank at which the one or more advertisements were displayed comprises:
calculating an average frequency with which the one or more advertisements displayed at a given rank were selected; and
calculating an average expected cost per one thousand impressions for the one or more advertisements displayed at the given rank.

9. The method of claim 8 wherein an impression comprises displaying a given advertisement.

10. The method of claim 8 wherein calculating an average expected cost per one thousand impressions comprises calculating a product of an average bid amount and an average quality score associated with the one or more advertisements displayed at a given rank.

11. The method of claim 8 wherein generating an aggregate landscape comprises generating a report indicating the average frequency with which the one or more advertisements were selected and the average cost per one thousand impressions for the one or more ranks at which the one or more advertisements were displayed.

12. The method of claim 11 wherein generating a report comprises generating a graph.

13. The method of claim 1 comprising generating an advertiser specific landscape for one or more advertiser specified advertisements associated with the bidded search term.

14. The method of claim 13 wherein generating an advertiser specific landscape comprises:
retrieving a quality score associated with the one or more advertiser specified advertisements; and
calculating one or more advertiser specific advertising metric values for the one or more advertiser specified advertisements using the quality scores associated with the one or more advertiser specified advertisements.

15. The method of claim 14 wherein calculating one or more advertiser specific advertising metric values for the one or more advertiser specified advertisements comprises calculating an advertiser specific bid amount indicating a bid amount needed for the one or more advertiser specified advertisements to be displayed at a given rank.

16. The method of claim 14 wherein calculating one or more advertiser specific advertising metric values for the one or more advertiser specified advertisements comprises calculating a frequency with which the one or more advertiser specified advertisements are to be selected at a given rank.

17. A system for generating a forecast of the performance of one or more advertisements associated with a given bidded search term, the system comprising:
a data warehouse operative to store advertising metric data for one or more advertisements associated with the bidded search term;
a back end service operative to:
aggregate the advertising metric data associated with the one or more advertisements according to a rank at which the one or more advertisements were displayed; and
calculate one or more advertising metric values for the one or more advertisements displayed at a given rank; and
a front end service operative to generate an aggregate landscape indicating a performance forecast for the one or more advertisements using the one or more advertising metric values.

18. The system of claim 17 wherein the data warehouse is operative to store advertising metric data indicating a rank at which the one or more advertisements were displayed in a ranked list of advertisements.

19. The system of claim 17 wherein the data warehouse is operative to store advertising metric data indicating a bid amount associated with the one or more advertisements.

20. The system of claim 17 wherein the data warehouse is operative to store advertising metric data indicating a quality score a given advertisement.

21. The system of claim 17 wherein the back end service is operative to aggregate the advertising metric data received according to the rank at which the one or more advertisements were displayed in a ranked list of advertisements in response to a search request comprising the bidded search term.

22. The system of claim 17 wherein the back end service is operative to calculate an average frequency with which the one or more advertisements were selected at a given rank.

23. The system of claim 17 wherein the back end service is operative to calculate an average expected cost per thousand impressions for the one or more advertisements displayed at a given rank.

24. The system of claim 17 wherein the back end service is operative to calculate an average quality score for the one or more advertisements displayed at a given rank.

25. The system of claim 17 wherein the front end service is operative to generate an aggregate landscape for the bidded search term.

26. The system of claim 17 wherein the front end service is operative to generate an aggregate landscape in response to an advertiser request comprising the bidded search term.

27. The system of claim 17 wherein the front end service is operative to generate an aggregate landscape indicating an average frequency with which the one or more advertisements are to be selected at a given rank.

28. The system of claim 17 wherein the front end service is operative to generate an aggregate landscape indicating an average expected cost per one thousand impressions for the one or more advertisements displayed at a given rank.

29. The system of claim 17 wherein the front end service is operative to:
receive a request identifying one or more advertiser specified advertisements associated with the bidded search term;
retrieve a quality score associated with the one or more advertiser specified advertisements;
calculate one or more advertiser specific advertising metric values for the one or more advertiser specified advertisements using the quality score associated with the one or more advertiser specified advertisements; and
generate an advertiser specific landscape using the one or more advertiser specific advertising metric values.

30. The system of claim 29 wherein the front end service is operative to calculate one or more advertiser specific advertising metric values using the quality score associated with the one or more advertiser specified advertisements and the aggregate landscape associated with the bidded search term.

31. The system of claim 29 wherein the front end service is operative to:
calculate an advertiser specific bid amount indicating a bid amount needed for the one or more advertiser specified advertisements to be displayed at a given rank in response to a search request comprising the bidded search term; and
calculate a frequency with which the one or more advertiser specified advertisements are to be selected at a given rank when displayed in response to a search request comprising the bidded search term.

32. The system of claim 31 wherein the front end service is operative to generating an advertiser specific landscape indicating the frequency with which the one or more advertiser specified advertisements are to be selected and the bid amount for the one or more advertiser specified advertisements at a given rank.
